(19) United States
(12) Patent Application Publication
(10) Pub. No.: US 2014/0351163 A1
(43) Pub. Date: Nov. 27, 2014

(54) SYSTEM AND METHOD FOR PERSONALIZED DELIVERY VERIFICATION

(71) Applicant: Kevin Alan Tussy, Las Vegas, NV (US)

(72) Inventor: Kevin Alan Tussy, Las Vegas, NV (US)

(21) Appl. No.: 14/284,391

(22) Filed: May 21, 2014

Related U.S. Application Data
(60) Provisional application No. 61/825,976, filed on May 21, 2013.

(51) Int. Cl. G06Q 10/08

(52) U.S. Cl. CPC G06Q 10/083
USPC 705/330

(57) ABSTRACT

The methods and systems disclosed enable objective verification of the delivery of goods based on comparative data sets; one associated with a given address location and the other associated with retrieved positional coordinates using a global positioning system (GPS) while at the location of delivery, with the retrieved coordinates tagged to a digital photograph of the intended recipient. Comparative data sets are also obtained from a digitized photograph showing an intended recipient's face, the photograph provided by the customer requesting the delivery, and from a photograph taken at the location of delivery to the recipient. Facial recognition technology is utilized to determine if there is a match between the two images. Satisfaction and assurance of delivery is further achieved by delivery to the customer of the photograph taken at the location of delivery showing the recipient with the goods.

### 1. PRIORITY CLAIM

This application claims priority to and the benefit of U.S. Provisional Patent Application Ser. No. 61/825,976 filed May 21, 2013.

### 2. FIELD OF THE INVENTION

The present invention relates to a personalized system utilizing the Internet and connectivity thereto by computerized devices for confirming delivery of products and gifts to their intended destination or to the intended recipient and methods for doing same.

### 3. BACKGROUND

Delivery services are a widely used in today's age. When a person or company needs to have goods shipped from one place to another, they enlist services of a delivery service provider. Delivery services originate in a variety of ways. Goods can be ordered online using the Internet from an online retailer and delivered to the purchaser or the intended recipient's address. Goods can also be purchased at a point of sale and delivered, accordingly, to an intended recipient if purchased as a gift or to the purchaser's home if the goods are too heavy or too large to for the purchaser to take home on their own. The delivery service provider might be associated with the store from which it was purchased or a contracted service. There are also services that combine the purchase of a product with its delivery. This is commonly found in the floral industry where flowers are purchased and delivered to another.

The delivery service may deliver the goods by foot, airplane, truck, van, car, or bicycle. Often times, multiple modes of transportation are used to transport the goods from their origination point to their final destination.

The delivery of the goods may be from one location to another within the same local area, between states, or all the way across the world to a variety of other countries.

When the goods or package are delivered, the deliverer typically will note the occurrence of a satisfactory delivery to the final destination by making a log entry to the deliverer's log or journal. This information may ultimately be sent to the customer that originated the delivery order indicating the completion of delivery. The customer may even be able to look up the event and track the progress of the delivery online at an Internet site associated with the delivery service or by calling the service for information. In all such instances, the customer must rely on the relayed information from the deliverer that the goods or package were delivered to the correct location and/or the intended recipient.

### SUMMARY

The present invention is directed to systems and methods for verifying the delivery of goods or the providing of services to the correct location and individual. The verification is objective based on external data and is not based merely on the affirmations of the person making the delivery. The verification is further accomplished in a personalized manner whereby the sender of the goods may receive not only objective, external confirmation that the goods were delivered to the correct location and to the correct individual, but may also receive a picture memorializing the delivery at the time it happened. The picture is of the recipient of the goods and may further include the goods in the possession of the recipient. This serves as another level of confirmation of delivery on top of the delivery driver's assertions and the objective, external data that is obtained.

The system and method disclosed herein provides numerous advantages. It would be advantageous if the customer were able to receive added assurance and verification of delivery that went beyond reliance on information relayed by the person that delivered the package. It would also an advantage to receive a secondary source of confirmation that the goods or package was delivered to the correct location and to the correct recipient. It would be a further advantage if the customer could visually see for themselves that the goods were delivered to the correct location or to the correct recipient. Yet another advantage would be confirmation that the goods or package were in the possession of the recipient and, most apropos in the instance when the goods are a gift, that the recipient was enamored with having received the goods.

In one embodiment of the invention, a system associated with a network provides the ability for various computerized devices to communicate. The delivery driver possesses a mobile device that wirelessly communicates through the Internet to a server or other computer device located at or associated with the delivery service provider. The customer that ordered the goods for the recipient may also have possession and use of a computerized device for sending in the delivery order and for later receiving confirmation of delivery. The mobile device used by the driver includes a camera and global positioning system (GPS) module. The driver uses these items to take a picture of the recipient of the goods with the goods and to tag the image with positional coordinates derived by the GPS module, respectively. The image and tagged data is compared to the positional coordinates of the address provided by the customer when entering her order to see if they are sufficiently the same. The address provided by the customer may need to be first converted to positional coordinates to allow for proper comparison. If a sufficient match between the two sets of positional coordinates is determined, the picture is delivered to the customer with an indication that the location of delivery was confirmed.

Another aspect of the above embodiment is to impress a watermark onto the picture upon verification that the goods were delivered to the proper location, as determined by comparison between the GPS provided positional coordinates and those of the address provided by the customer. The watermark serves as the indication of confirmation. It may also serve as a promotional device to remind the customer of the delivery service provider including, perhaps, contact information, in a manner that secondarily (or primarily) provides the customer with an enjoyable memento.

Various functions of the above embodiment may be performed on the driver's mobile device and other may be performed at the server or other computerized device associated with the delivery service provider. Different embodiments can have some of such functions performed at the different locations. However, the network system allows for the communication and transfer of data between each of the computerized devices to ensure all functions are carried out.

In another embodiment of the invention, facial recognition technology is used to verify that the recipient of the goods was the intended recipient, as designated by the customer. A similar system is provided as in the above-described embodiment. However, in this embodiment a camera and facial recognition modules reside on the driver's mobile device. In one embodiment, a facial detection module resides on the driver's mobile device and a facial recognition module resides at the server or other computerized device associated with the delivery service provider. The former module is used to focus in on one or more faces in a digital photograph to best frame it for facial recognition and the latter processes the image using various algorithms that identify the myriad features of the facial image. The driver takes a picture of the recipient of the goods and facial detection is applied to the resultant picture. A new picture may be created of just the face and submitted to the facial recognition module for processing there. The results of the facial recognition process are then compared to results of a facial recognition process applied to a picture of the intended recipient provided by the customer. If there is a sufficient match between the two pictures, objective confirmation is obtained that the goods were delivered to the proper recipient.

This embodiment may be used in association with the embodiment that serves to deliver objective, external confirmation of delivery to the proper location. In such a combined embodiment, the same picture is used with both systems and processes. Upon confirmation that that goods were delivered to the proper recipient, the original picture taken of the recipient, which would include the goods, would be sent to the customer in lieu of the picture created using the facial detection module. A watermark could similarly be impressed in the picture, regardless of which is sent to the customer, to indicate confirmation of delivery to the correct recipient.

These and other details, aspects, embodiments, features, and advantages described herein and will become better understood with reference to the following detailed description, accompanying figures and the claims.

### BRIEF DESCRIPTION OF THE DRAWINGS

FIG. 1 is a block diagram showing the basic elements of the system.

FIG. 2 is a block diagram showing a basic embodiment of a mobile device.

FIG. 3 is a block diagram showing embedded features of an embodiment of a mobile device and server for a delivery verification system based on verification of location.

FIG. 4 is a block diagram showing the embedded modules of an embodiment of a mobile device and server for a delivery verification system based on verification of the recipient.

FIG. 5 is a flow chart showing the method steps of an embodiment for a delivery verification process based on verification of location.

FIG. 6 is a flow chart showing the method steps of an embodiment for a delivery verification process based on verification of the recipient.

### DETAILED DESCRIPTION

The present invention is directed towards the verification and confirmation of delivery of goods delivered by a delivery service to a specific location or individual. One embodiment provides for verification that the goods were delivered to the intended location of delivery. Another embodiment of the invention provides for verification of that the goods were delivered to the intended individual. As will become apparent, global positioning system (GPS) technology is utilized to allow for location-based verification of delivery while facial recognition technology is utilized to allow for verification of delivery to an intended individual. Both aspects require the use of a network system whereby computers and computerized devices are enabled to digitally communicate to and receive digital communications from one another through the network system.

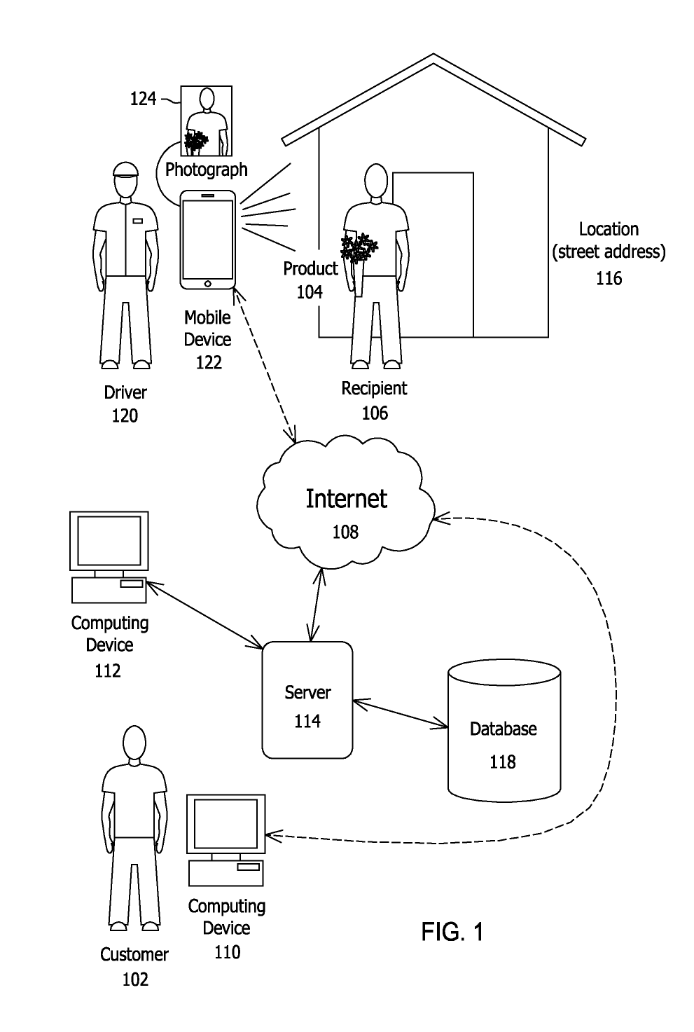

FIG. 1 shows an exemplary environment for which the personal delivery verification system described herein will be used. It is contemplated that, after reading the specification provided below in connection with the figures, one of ordinary skill in the art may arrive at different environments of use and configurations. In this environment, a customer 102 of a delivery service provider wishes to have a product 104 delivered to a recipient 106. In a preferred embodiment, the product 104 is a gift or personal item. The reasons for this will become apparent. The present invention can be similarly utilized with any type of product, but due to a distinct personal aspect of the invention, it is best utilized in association with the delivery of gifts.

The customer 102 places an order with a delivery service (not shown) to deliver the product 104 to the customer. The order can be placed through any conventional or nonconventional means, including an in-person order made to one who receives orders at the point of service. The order can also be made by telephone to a person who takes order over the phone or delivered on an order form through normal channels used for the delivery of physical mail and other items. In a preferred embodiment, the order is made online through a network, preferably the Internet 108, using a computer 110 or computerized device such as a smart phone, lap top computer or computerized tablet device.

Submission of orders through the Internet 108 or any other network (public or private) is best enabled through an online order form residing on a computer device 110 or server 114 that can be accessed by the customer, preferably at a website established by the delivery service. The order information includes such information as the customer's identification, a source for payment for the services such as a credit card or debit card number or billing address, the recipient's identification information, the product being purchased for delivery, and the street address location 116 of delivery. As will become apparent, additional information not necessarily needed by the delivery service for delivery of the product 104 is required, such information being the physical address or e-mail address of the customer 102. This information will enable another feature in regards to the present invention, but can secondarily be used to provide the customer with promotional materials, information and offers. In another embodiment, a digital image of the recipient's face is provided to the delivery service. As will become apparent, the digital image can be later used to verify delivery to the proper person.

Order information received by the delivery service from the customer 102 is stored in a database 118 for later retrieval. The order information is input to the database 118 manually or by using a database software application residing in a computer 112 or server 114 comprising machine readable instructions that cause a controller to have data read by a reader from each of the defined fields of the order information form and copy the data to an assigned field of a database 118. There it is stored as a database record with a plurality of other records obtained from information provided from other orders. These devices will be defined in further detail, below.

A delivery person, which in the embodiment of FIG. 1 is a driver 120, is assigned the task of delivering the product 104 to the recipient 106 using a delivery means such as a delivery van. The delivery service provides the driver 120 the recipient's identification information including, in one embodiment, the recipient's photographic facial image, and the location 116 of delivery. The driver 120 also possesses a mobile device 122. The mobile device 122 can be any portable computerized device including but not limited to a laptop computer, smart phone or tablet. The mobile device 122 is configured for wireless communications through the Internet 108 or any other network (public or private) which allows for communications with the server 114 and other devices that also configured for wireless communications using the Internet 108. E-mail communication and SMS texting may comprise modes of digital communication through the Internet subject only to availability of those respective modes of communication on the mobile device 122. E-mail, SMS and other forms for digital communication include a functionality that allows for attachment of additional digital data comprising items such as documents and images which may then also be delivered through the Internet 108. The mobile device 122 also includes a module for global reckoning; e.g. a global positioning system or GPS, and a camera for taking digital photographs. These aspects of the invention, including the mobile device, will be described in greater detail, below.

The system environment in this embodiment includes delivery of the product 104 by the driver 120 to the recipient by driving the delivery van to the recipient's location 116. The location 116 can be obtained by the driver 120 from the database 118 by accessing the server 114 from the driver's mobile device 122. Alternatively, input of a user ID and password, or other security measures, may be provided by the driver 120 as a prerequisite for access to the database. Both the customer and recipient's information might be classified as private information accessible only by authorized users of the system, and such information may have only been provided by customer 102 under terms and conditions making such information private and only accessible by authorized personnel having been provided security access to the database 118 by the delivery service.

Upon arriving at the destination location 116, the driver 120 delivers the product 104 to the recipient 106. In one embodiment, the driver 120 requests that the recipient 106 pose for a photograph with the product 104. If the recipient 106 complies, the driver uses mobile device 122 to take a photograph 124 at the location 116 showing the recipient holding or having in near proximity the product 104 to create a digital image of both the recipient and product.

In another embodiment, the driver 120 requires that a photograph be taken only of the recipient 106. It is inconsequential in this embodiment if the photograph is taken at location 116 or if the digital image created includes the product 104.

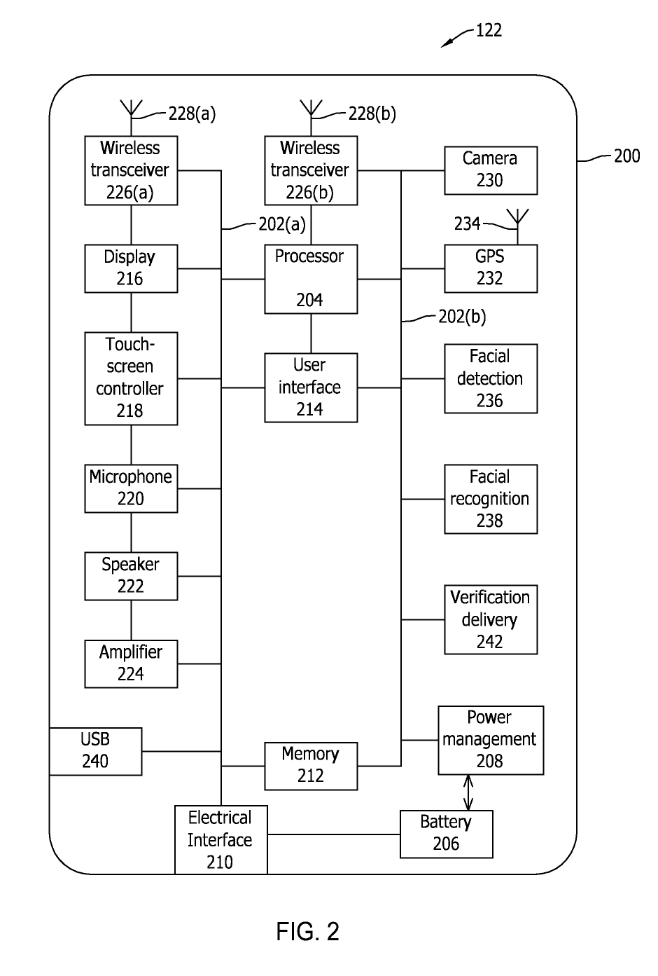

Referring now to the exemplary mobile device 122 of FIG. 2. The mobile device 122 of FIG. 2 is one of many that could be contemplated by one of ordinary skill in the art for use with the present invention may comprise any type of mobile device, including a smart phone, tablet computer, laptop computer or personal data assistant.

In the present embodiment of FIG. 2, the mobile device is configured within a casing 200 to protect the inner firmware, integrated circuitry and peripheral devices. A number of bus elements 202(a), 202(b) link the various software modules and peripheral devices to the processor 204 for communication. The processor 204 may comprise a general purpose processor, ASIC, ARM, DSP, controller, or any other type of processing device. Power is provided for enabling the processor 204 to operate through battery 206 which may be managed for optimum and directed use by power management module 208. Being a mobile device, a battery is generally required, but the mobile device may receive power from alternative sources using the electrical interface 210, such as a connection direct to an electrical outlet, a charging station, a car charger or other power supply. These alternate power sources may provide direct power to the processor or, more likely, are used to recharge the battery 206 for further use as the primary power source.

At least one memory 212 storage unit is contained within the casing to store machine readable code, or machine executable code in a non-transitory format. Such code, also known as software, is executable on processor. Such code may comprise various applications that can be executed on the mobile device 122 through use of the processor not separately stored in firmware devices. The memory 212 unit is also used to store data files for various items including digital images, digital documents, digital sound, digital animation, or any other type of digital data. The machine readable code can be stored in non-volatile memory sources such as ROM or in volatile memory such as RAM, or other sources as known by those skilled in the art.

A user interface 214 accepts input from the user of the mobile device 122. The user interface 214 may be partially provided as a graphical user interface or GUI whereby input points and inputs are visually represented. Such input includes the selection of an application for execution, the input of data, controlling various device parameters. The GUI is displayed on a display 216. Input can be provided by various mechanisms, including a touch screen controller 218 that senses capacitive resistance when the display screen is externally touched. Other mechanisms for input may include a tactile keyboard, roller ball, buttons, wheels, touch pad, scrolling device, mouse and pointer.

The mobile device 122 display 216 is used for viewing data, images and animations. The display 216 can be of any type known by those skilled in the art including LED, LCD, thin film transistor screen, OEL, CSTN (color super twisted nematic), TFT (thin film transistor), OLED (organic light-emitting diode), or AMOLED (active matrix organic light emitting diode). The processor 204 sends machine readable code to the display where it is translated by a controller (not shown) to display delivered image, text or animation.

The mobile device 122 also includes a microphone 220 for sending sound and a speaker 222 for receiving sound. The processor 204 interprets sound signal—in the case of the microphone sound waves—and converts such to digital data. Conversely, the processor 204 receives digital data and converts such to sound waves so that the person in possession of the mobile device 122 can hear the digital data as sound. Controllers (not shown) associated with such devices may be used in association with the processor 204 for the conversion process and other peripheral functions. An amplifier 224 is generally included for volume control.

The mobile device 122 further includes at least one wireless transceiver 226(a), 226(b) which is in association with the bus 202(a), 202(b) circuitry for receiving information from the processor 204 and a respective antenna 228(a), 228(b) for wirelessly receiving and sending information. The wireless transceiver 226(a), 226(b) is configured to receive from the antenna 228(a), 228(b) incoming signals from a remote transmitter and perform analog front end processing to generate analog baseband signals. The incoming signal may be further digitally processed using an analog to digital converter to put the signal in the proper format for subsequent processing by the processor 204. Conversely, the transceiver 226(a), 226(b) is configured to receive outgoing signals from the processor 204 or other module or sub-component of the mobile device 122. Such signals are converted from baseband to radio frequency (RF) signals for transmission out through the antenna 228(a), 228(b).

Any wireless standard now existing or later developed can be used for transmission and receiving of wireless signals and are only limited by the capabilities of the computerized devices used by the system. Such standards include, but are not limited to, Bluetooth, WI-FI such as IEEE 802.11a,b,g,n, wireless LAN, WMAN, broadband fixed access, WiMAX, any cellular technology including CDMA, GSM, EDGE, 3G, 4G, 5G, TDMA, AMPS, FRS, GMRS, citizen band radio, VHF, AM, FM and wireless USG.

The elements of the mobile device 122 described thus far are typical elements found on nearly all if not all of today's mobile devices. The elements now to be described are not as common. Thus, in the present invention, the mobile device 122 also embodies a camera 230. Although this component is also fairly typical on mobile devices of today, it is not as typical as the more common elements described above. The camera 230 is generally an optional component, not necessary to carry out the primary functions of a mobile device 122, and therefore some people opt to purchase mobile devices that do not include them. However, in preferred embodiments of the present invention, a camera 230 is required.

The camera 230 can provide both still and video images. The digital images are then stored in the memory of the mobile device 122 for later viewing on the display 216 of the mobile device or for transmission to another computerized device capable of receiving transmissions from the subject mobile device. Once received, the image or video is transformed back into its digital format so that it can be read and displayed on the display of the computerized device that received it. All peripheral elements associated with a camera 230 may reside in the mobile device 122 such as a flash, software for editing the digital image, and the power management module 208 for managing the power and voltage to the camera and flash as provided by the battery 206.

In one embodiment, the mobile device 122 includes a GPS module 232 also in association with the bus 202(a), 202(b) circuitry for the receiving and sending of electronic information. The GPS 232 uses an antenna 234 for receiving information. The GPS 232 receives signals from overhead satellites or other transponders to generate location data regarding the location, direction of travel, and speed of the mobile device 122 containing the GPS 232.

In another embodiment, the mobile device 122 optionally includes either or both a facial detection module 236 and facial recognition module 238. As will be later discussed in more detail, either or both the face detection module 236 and face recognition module 238 can reside optionally on the server 114. The facial detection module 236 includes one or more software encoded algorithms that detect a face within a digital image. The facial recognition module 238 embodies software encoded algorithms that analyze the features of a facial image and converts searched for elements into biometric data. The biometric data can then be compared to other images for similarities and dissimilarities. If a certain threshold level of biometric similarity is discovered as between two separate images, it is determined that a match has been made and that the images are those of the same person.

A USB interface 240 is provided for receiving and sending data in a non-wireless mode. The USB interface 240 can also be used for receiving power from a power source to recharge the battery 206.

Also included with the mobile device 122 is a verification delivery module for enabling the process of verifying delivery of the product 104 to the correct location 116 or to the correct recipient 106. It may be that the verification delivery module 242 includes machine readable instructions for performing both verification of correct location 116 and verification of correct recipient 106, but the verification delivery module 242 need only include machine readable instructions for performing one of the two. Further, the verification delivery module 242 need not perform any of the verification processes on its own but merely function as an overlay or manager to direct the necessary outcomes and consolidate the outcomes into a result that is useable by the delivery service provider.

Other modules, software and devices may be included in the mobile device, which are known to those skilled in the art, but need not be discussed here. Further, each of the noted components, devices, software described above are also know to those skilled in the art and a more detailed discussion that that provided is therefore unnecessary for purposes of the present invention.

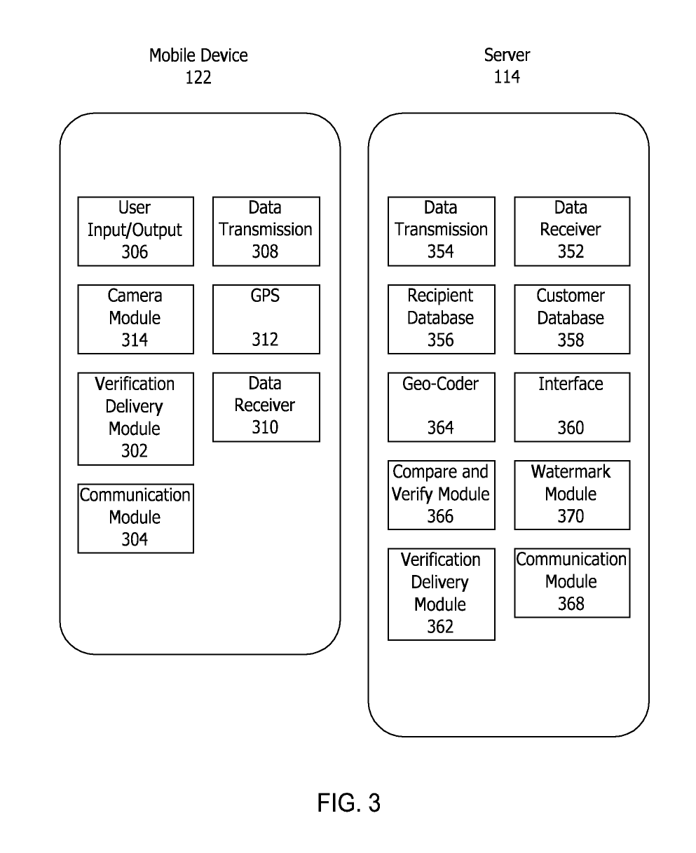

FIG. 3 illustrates exemplary software modules and integral applications that are part of the mobile device 122 and server 114 for an embodiment that verifies the delivery of product 104 based on location. Some of the software modules were described above. Here, discussion will be directed more closely with their functionality in association with the given embodiment of the invention.

The verification delivery module 302 (referenced as 242 in FIG. 2) is an application downloaded from a source location to the driver's mobile device 122. The download can occur wirelessly through one of the wireless transceivers 228(a), 228(b). Alternatively, verification delivery module 302 can be downloaded to the mobile device 122 through installation of software direct from any media source whereby the mobile device is able to gain access to such media through the USB port 240 of the mobile device or other connection port enabled for the transfer of electronic data. But the verification delivery module 302 application is not a software module that would normally be included in a mobile device 122 but an application that is later transferred to the mobile device for the purpose of verifying deliveries per embodiments of the present invention.

After the driver 120 arrives at location 116 and delivers the product 104 to the recipient 106, the driver uses camera module 314 (referenced as 230 in FIG. 2) to take a digital photograph 124 of recipient 106 holding or in close proximity to the product 104 so that both the recipient and the product are included in the photograph. Verification delivery module 302, running in the background on the mobile device 122, reads the GPS positional information obtained by the GPS module 312 (references as 232 in FIG. 2), which is the position of the mobile device when the photograph was taken, and verifies that the digital image is tagged or embedded with that digital information. If it is not tagged with the GPS positional information, verification delivery module 302 embeds that information into the digital image so that it is. The positional information can be based on any coordinate or location-based reckoning, including latitude and longitude or the UTM (universal transverse Mercator) system, but is preferably a system based on latitude and longitude, which is typically utilized by most GPS devices for determining location over the face of the Earth how most mobile devices with geo-location tagging capabilities tag photographs taken with the device.

Once the driver 120 has the digital image of the recipient 106 and product 104 together, the image is uploaded wirelessly to the server 114. Verification delivery module 302 may do this automatically or prompt the driver 120 to send the digital image. Verification delivery module 302 may also include a menu with selectable options to enable the driver 120 to manually determine where and when to upload. Verification delivery module 302 may also include selectable options in regards to whether location-based verification or recipient-based verification is sought. Once selected, a series of other selectable options may ensue that are associated with the selected type of verification.

The digital image is sent wirelessly using communication module 304 through the wireless transceiver 226(a), 226(b), subject to any prerequisite digital signal processing. The communication module 304 can support any mode of wireless data communications, such as e-mail and text messaging, using any protocols now known or later developed.

The user I/O module 306 gives the driver 120 the ability to enter data and make selections from the verification delivery module 302 user interface and from input fields within the communication module 304; and to view data received on the display 216 or hear sound synthesized from digital sound data over the speaker 222.

Also shown in FIG. 3 is the server 114 containing various software modules. The server 114 resides at a remote location and the reason wireless communications are necessary as between the server and mobile device 122. It is understood in the art that the software modules need not all be located on the same server but may utilize a distributed processing approach with multiple servers, other processor-based devices, such as general computers, and databases operating together to provide a unified server. Thus, although all modules are shown in FIG. 3 in one location, it is understood that they could reside at different locations within different servers or other processor-based elements but working together in a unified fashion.

As shown in FIG. 3, the server 114 includes a data receiver module 352 and a data transmission module 354. These modules are configured to receive data from remote devices configured with their own data transmitter module, such as the data transmission module 308 of mobile device 122, and transmit data to remote devices configured with their own data receiver modules, such as the data receiver module 310 in mobile device 122. The remote module must be configured with access to the same networks and protocols as the server 114 in order to receive and send the signals to and from the server.

A recipient database module 356 contains record information regarding recipients of the delivery service provider, including the recipient location. A customer database module 358 contains record information regarding customers, the actual customers of the delivery service provider. Each of these database modules 356 and 358 need not be modules within the server but, as described above, could reside separate and remote from the server. In such instance, an interface at the server 114 provides a link to the databases 356 and 358 where the information is stored. In a preferred embodiment, the customer 102 provides the delivery service their e-mail address or mobile phone number so that photographs taken by the driver 120 of the recipient 106 may be delivered electronically to the customer.

Some of the component functions of the verification delivery module 362 may reside on the server 114 and provide verification of the image uploaded by the mobile device 122 to the server 114. In so doing, the respective components of the verification delivery module 362 calls for and receives, or instructs delivery service personnel managing the verification delivery module to call and receive, the recipient 106 location 116 from the recipient database 356. If the customer 102 provided the location 116 to the delivery service in the form of a street address, the location of the address is identified and converted to positional coordinates using the address geo-coder module 364. The geo-coder module 364 that readily converts street addresses to positional information in the form of latitude and longitude. These types of software applications are widely available today and can be found on numerous sites across the Internet.

The verification delivery module 362 also searches for or directs another software module to search for the positional coordinates tagged to in the digital photograph 124. The positional coordinates are generally in the form of latitudinal and longitudinal coordinates contained in the metadata information that is associated with each digital image or video taken by many camera-enabled mobile devices of today, and some standalone cameras. Metadata includes many items of information; not only positional coordinates of the mobile device at the moment image creation. Other metadata information may include the time and day, the camera type, the parameters used when taking the photograph, among other things. Metadata is information associated not only with images, but also digital documents, web pages, digital music and sounds, and other digitized items capable of having hidden, extraneous and peripheral information piggybacked to the them. In digital images, the metadata is stored in an EXIF (exchangeable image file format) file. Metadata stored within the EXIF file is generally not editable and therefore conducive for use with the present invention to reduce potential errors in verification Other file types used to store metadata with digital images are IPTC (developed by International Press Telecommunications Counsel) and XMP (extensible metadata platform). However, these two file types are editable to allow a user to insert additional information, as they desire.

The positional coordinates of the location 116 as captured from the EXIF metadata of the digital image are compared using the compare and verify module 366 to those of the street address provided by the customer 102 and received from the recipient database 356 (after conversion of the street address to the recipient 106 using the address geo-coder module 364). If there is a match between the two sets of positional coordinates, verification is achieved and the delivery service is notified of the match. Since the latitude and longitude coordinates obtained by GPS module 312 generally provide very exacting positions, it is unlikely that the recipient's street address coordinates will precisely compare with those coordinates tagged to the digital photograph. Therefore, a certain degree of differentiation may be considered acceptable by the compare and verify module 366 and still provide verification of delivery to the proper location. The margin of differentiation could be variable or pre-defined; or it could be a subjective decision to be made by the user of verification delivery module 302, 366.

A communication module 368 similar to the communication module 304 residing in the mobile device 122 resides in the server 114. The communication module 368 is for at least communicating with the driver 120 and the customer 102. If verification is not received, notification may be sent using the communication module 364 to the driver 120 providing the driver the opportunity to discover why a proper match between the two coordinate positions could not be achieved. A new photograph may be taken and uploaded once again to the server 114 where it will once again be compared to the recipient's street address 116. Additionally, the GPS module 312 may be assessed to see if it is properly working or if the GPS module had been deactivated.

Upon verification, the digital image is watermarked using the watermark module 370. The watermark may comprise a logo or source identifying mark of the delivery service. The application of the watermark image indicates verification of delivery of the product 104 to the proper location. Therefore, the watermark is an attribute indicating proper delivery as determined by verification delivery module 362.

The communication module 368 sends the watermarked digital image to the customer 102. Upon receipt, the customer 102 sees the image of the recipient 106 with the product 104 and therefore knows that the recipient received it. The watermark further indicates verification that the product 104 was indeed delivered by the driver 120 to the correct location 116. This provides the customer 102 with an added level of assurance that the delivery was received.

The customer 102 now possesses the watermarked image of the recipient 106 and product 104. Having just received the product 104, the recipient 106 is likely to be in a pleasant frame of mind so that when the driver 120 took the photograph, the recipient was most likely smiling or, at least, grinning. As is often the case with photographs; especially those that show the subject of the photograph—the recipient 106—in good pose with the recipient's newly received product 104 (which may be a gift such as a bouquet of flowers), the customer 102 is inclined to print it (if not already printed) for viewing, framing, hanging or tape it to a wall, or for attaching it to a magnetic surface, such as the refrigerator, with a magnet. In fact, the delivery service provider could send the photograph to the customer in any one of these ways, included as a digital image sent through the Internet. The customer 102 might also leave it on the customer's computer device as a screen saver or the like so that it is regularly seen while using the computer device. Thus, the photograph will be enjoyed by the customer 102 for some time and serve as a pleasant reminder of the delivery service provider's customer service. It will also make the customer more inclined to use that delivery service in the future and the photograph will serve as a reference when the customer should have the need for those type of services, once again. The picture may also be provided to the recipient of the goods or services as a reminder of the goods or service that was provided to them. For example, the recipient may provide their email or phone number to the delivery person and thus be sent the photo.

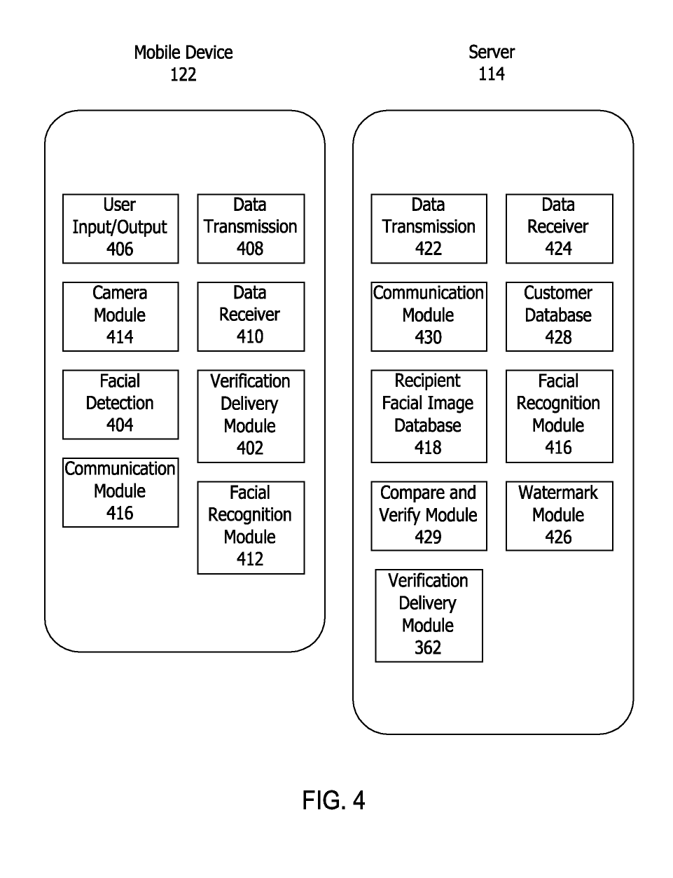

In another embodiment, in addition to or in lieu of location-based verification of delivery, the system includes facial recognition technology to verify delivery to a specifically identifiable individual. Referring now to FIG. 4, the mobile device 122 includes many of the same software modules as the location-based verification embodiment; a data transmission module 408 for delivery of digital data, a data receiver module for receiving digital data, a communication module 416 for managing the incoming and outgoing digital data in the form of e-mail or text messages, and the input/output module 406 which allows the user to accept data from and display data to the user. This embodiment also includes a camera module 414. The camera module 414 includes a digital camera which is also used for taking a digital photograph of the recipient 106. The verification delivery module 402 also resides in the mobile device 122 to manage the various functions of the verification system and provide a user interface to enable its use. As with the location-based verification embodiment, the mobile device 122 is used by the driver 120 to take a digital photograph of the recipient 106 and upload the image to the server 114.

As mentioned in the discussion related to FIG. 1, a face detection module 404 and a face recognition module may reside on the mobile device 122. If not included on the mobile device 122, either or both would then reside on the server 114. The functions of facial recognition can therefore be achieved in whole or in part at either the mobile device 122 or server 114. In a preferred embodiment, the facial detection module 404 resides on the mobile device 122 and the facial recognition module 412 resides on the server 114.

The digital image taken by the driver 120 is assessed by the facial detection module 404. Using algorithmic calculations, the facial detection module 404 detects a face within the digital image and focuses just on that area of the image that includes only the face. The facial portion of the image is then cropped so that a newly formed image exists consisting primarily of only the person's face and adjusted to place the image in best form for facial recognition. Facial recognition processing is known in the art and as a result will not be described in detail, herein. Suffice it to say, in running the digital image through the facial detection module 404, the entire image need not be processed by the algorithms of the facial recognition module 412 and, if the image is to be uploaded to the server, as is the case in a preferred embodiment, a lesser amount of data transfer is required and the bandwidth requirements and energy consumption levels are therefore reduced.

Although a preferred embodiment has the facial recognition performed at the server 114, it may also be performed at the mobile device 122. An advantage in this might be to more quickly verify identification and also eliminate the need to transfer data wirelessly to the server 114. However, significantly greater limitations concerning the memory storage and processing power capabilities of the mobile device 122 versus those of the server 114 may warrant uploading of the digital image to the a facial recognition module 412 residing on the server 114.

As mentioned previously, the facial recognition module 412 uses algorithms to analyze features of the face and converts them to biometric data. The biometric data is then compared to different images for similarities and dissimilarities, resulting in a percentage match between images. Because facial recognition processing is known in the art, it will not be described in further detail. Needless to say, if the percentage match is sufficient, as determined by the user or the by established parameters, then the images will be deemed those of the same person. If the identification of one of the images is known, then the identification of the other image is also known. Facial recognition has many uses. But here we need only concentrate on one—the verification of product 104 as delivered to an intended recipient 106.

Coinciding with the upload of the digital image to the server 114, components of the verification delivery module 402 system residing on the server access the recipient facial image database 418 and calls the digital image provided to the delivery service by the customer 102 in association with the order and delivery of the product 104. This may be performed prior to, at the same time, or subsequent to the upload of the digital image taken by the driver 120. The digital image uploaded by the driver 120 could also be in its original form with facial detection applied by the facial detection module 404 at the server 114. The data transmission module 422 and data receiver module 424 are used for transferring data as between the mobile device 122, server 114 and the various databases 418, 428; which need not be discreetly segregated as shown in FIG. 4, but could be combined into just one database or any number of databases. A compare function using the compare and verify module 429, which may be part of the facial recognition module 416, is performed between the digital image taken by the driver 120 and that provided to the delivery service by the customer 102 to determine if there is a match. If the biometric features of the two images contain sufficient similarities and not too much dissimilarity, they are considered within a certain percentage match. The facial recognition algorithms may give certain features more weight than others in determining a match, but as determined by the facial recognition module 416 and compare and verify module 429, a match between the two images is verified if within that certain accepted margin.

The watermark module 426 provides the same function as for the location-based verification embodiment described, above. Similar to that embodiment, information concerning the means for sending digital data to the customer 102 is retrieved from the customer database 428. The watermarked image is then delivered to the customer 102 using the communication module 430 and other applicable modules of the server 114. Alternatively, the watermarked image is downloaded to the driver 120, once retrieving the customer's e-mail or mobile phone number for SMS text messaging, sends the image to the customer 102. Additionally, though the facial image was used in the facial recognition process, the original digital photograph could be watermarked by the watermark module 426 and sent to the customer 102. The original image could include the recipient 106 holding or in close proximity to the delivered product 104 and might be the same photograph used to verify that the product 104 was delivered to the proper location 116. Thus, the one, original photograph can be used to both verify location of delivery and delivery to the intended recipient, and for sending to the customer 102 as a keepsake and promotional item.

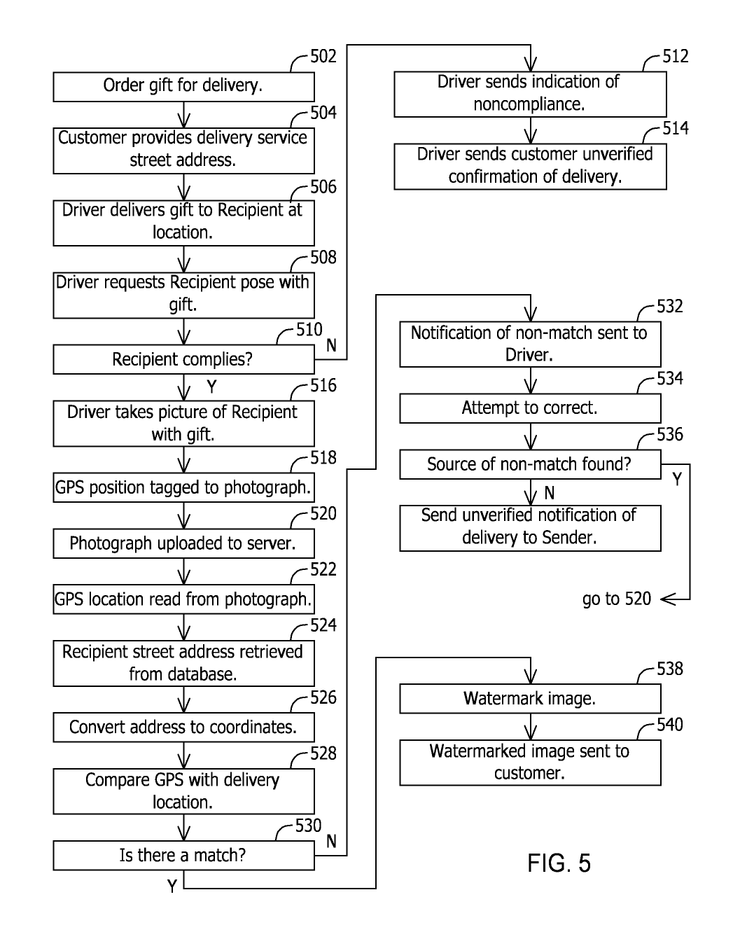

Referring now to FIG. 5, a flowchart is provided which shows an embodiment of the invention as a sequence of steps. The process is initiated when a customer orders the delivery of a gift, product or package 502. The gift in intended for delivery to a specified location. In another embodiment, which will be subsequently discussed, the package is delivered to a specified recipient. Thus, in this embodiment the customer provides the delivery service with the street address for delivery 504. A driver receives the gift from the gift's stored location and drives to the location 506. Once the gift is delivered, the driver will ask the recipient if they would like to pose with the gift 508. A photograph of the recipient with the gift is not truly required to verify location of delivery. A photograph of the structure or any other identifying feature that the customer is familiar with could provide verification that the gift was delivered to the proper location subject to the use of a camera that includes GPS functionality that provides metadata information regarding the positional coordinates tagged to the digital image showing the where the photograph was taken. However, as noted above, it is an advantage of the invention that the photograph is taken of the recipient together with the gift. This allows the customer to ultimately see that it has been received and further provides the customer a nice keepsake of the moment of delivery in the form of the digital image that can be stored and viewed on a computerized device or printed and displayed in any conceivable manner. With the inclusion of a watermark that is also a source identifier for the delivery service, a reminder and reference is also provided as to the provider's unique, quality service which, in turn, may lead the customer to secure their service again.

The recipient may not comply with the drivers request to pose with the gift 510. A negative response is unlikely. Especially if the gift is coming from someone they know. However, in the event the driver does receive a negative response, the driver sends an indication of such to the server 512 where it is received by personnel of the delivery service monitoring for such. A communication in the form of e-mail, text or voice is sent to the customer indicating an unverified delivery 514. The delivery is unverified only in the sense that a location based confirmation could not be achieved in the manner intended, such as through a GPS tagged digital image confirming positional coordinates generally in sync with those of the street address provided by the customer when ordering the gift for the recipient. Otherwise, the driver can provide confirmation in the normal course based on the driver's own assertions.

If the recipient does consent to be photographed, the driver takes a photograph of the recipient with the gift 516 using the driver's camera and GPS-enabled mobile device. The positional coordinates established through the GPS functionality are tagged to the digital image 518 as metadata. The digital image is then wirelessly uploaded to the server 520.

At the server, the positional coordinates tagged as metadata to the digital image taken by the driver are read 522. Also retrieved at the server is the recipient's location 524. This is generally in the form of a street address and so a conversion to the positional coordinates as that of the tagged metadata is performed 526. Once both sets of positional coordinates are obtained, one set from the digital image and one set from the location address provided by the customer when ordering the gift for delivery to the recipients location, a compare function is performed between the two sets of data 528. It is highly likely that the positional coordinates will not be a precise match, but will be within a given proximity of one another. A computational algorithm can then be used to establish the distance between the two coordinate sets to determine if there is a match 530. If the distance is outside an acceptable margin, then a match is not achieved. The driver is notified that a match could not be established between the two sets of positional coordinates 532 and the driver then attempts to determine the source of the problem and correct 534.

If correction involves having a new photograph taken of the recipient and gift, or if it involves making adjustments to the mobile device, wireless connection or GPS module therein, the prior image or newly taken image is uploaded once again to the server to continue the process from that point. If the source of the problem is not discovered, a notification of unverified delivery is sent to the customer. Once a match is verified between the two sets of positional coordinates, the digital image is imprinted with a watermark 538 indicating verification of matching locations. The watermarked image is then sent to the customer 540 providing the customer with confidence that the gift was delivered as intended to the correct location, with a photograph of the recipient actually having possession of the gift. The image, as previously discussed, can then be saved in a variety of ways and for the dual purpose of providing the customer with a nice photograph to remember the occasion and as a promotional article for the benefit of the delivery service provider. It is also contemplated that a link could be provided to a map showing the location of the delivery, and this would verify the location of the delivery. If the recipient is not home, then a picture of the house including house number could be taken as a verification of delivery at a particular address. This may supplement or replace GPS coordinates.

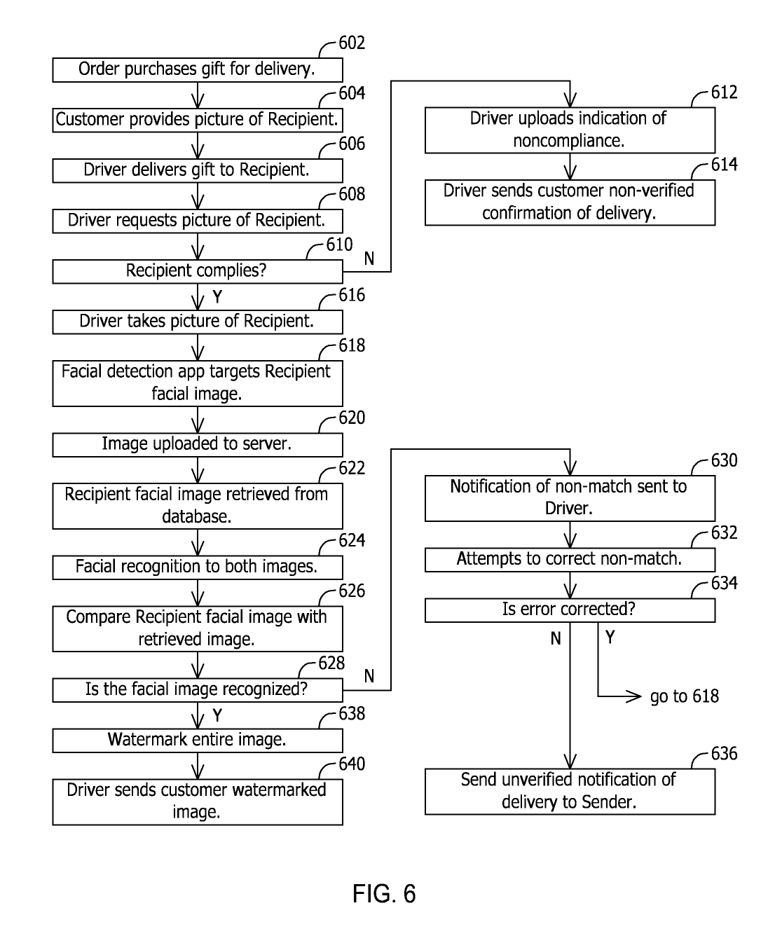

FIG. 6 shows the process verifying delivery to the intended recipient based on facial recognition. This form of verification can be provided in addition to the location-based verification of FIG. 5 or in addition to add an extra layer of verification to the process.

The steps are similar to those for location-based verification. The customer orders a gift for delivery to an intended recipient 602. In this embodiment, it is the recipient that is the primary source for verification as opposed to the location. Thus, in addition to providing the street address of the recipient, the customer provides the delivery service a photograph of the recipient 604. The gift is delivered to the recipient 606 and the driver asks the recipient if he can take a photograph of the recipient 608. If both location-based and individual-based verification is required, the same photograph can be used for both.

If the recipient does not comply with having her photograph taken 610, sends an indication of noncompliance to the server 612. A communication is then delivered to the customer indicating that verification could not be obtained through facial recognition due to lack of cooperation by the recipient 614. However, if the recipient does comply with having her photograph taken 610, the driver takes a photograph of the recipient 616.

Once the photograph is taken, a facial detection application is applied to the image 618. The application locates the person's face within the image and crops and adjusts the photograph to create another photograph that primarily shows the recipient's face and puts the new image in best form for the subsequent facial recognition step. The facial detection step can be performed on the driver's mobile device or at the server if original photograph is uploaded to the server. In a preferred embodiment, facial detection is performed at the mobile device while facial recognition is performed at the server. Regardless, the digital image is uploaded by the mobile device to the server 620. The photograph of the recipient provided by the customer is retrieved from a database 622 where it had been stored. Facial recognition is performed on both the digital image uploaded to the server by the driver and to the image provided by the customer 624. A comparison function is performed to detect similarities and dissimilarities between the two facially recognized images 626. Based on the various algorithms within the facial recognition application, and given a defined margin of error, the facial image from the photograph taken of the recipient by the driver is verified as the same or different from the photograph provided by the customer 628.

If a verification of match between the two photographs is not provided, the driver is sent a communication letting him know 630. Attempts to correct any situation that may have led to the negative outcome may be made 632. This could include adjustment of the facial detection software, adjustment of the facial recognition software, and/or the need to take another photograph of the recipient. The new photograph is then put through the same process in a new attempt to achieve a match between the new photograph and that provided by the customer. If this reiterative process does not produce a positive result 634, is not attempted or is no longer attempted, then a communication is sent to the customer notifying them of the situation 636.

Once a match is obtained between the photograph taken of the recipient and the photograph provided to the delivery service by the customer, a watermark is applied to the photograph taken by the driver 638. This could be the applied to the original photograph, the derivative photograph resulting from the facial detection process, or both. The watermarked photograph is then sent to the customer 640 indicating verification of delivery to the intended recipient.

It is also contemplated that the facial recognition match could be a prerequisite to delivery of the goods, item, or services. For example, when ordering or requesting receipt of a product or items, the recipient or sender may require that a facial recognition match occur before the goods or item will be delivered. This process may be useful when delivering money, checks, legal documents, or expensive or rare goods. In such as situation, the recipient may upload their picture (or it otherwise may be known). Then at the time of deliver (which can now be at any location), a picture is taken of the recipient. The prior uploaded picture (which is trusted or verified) is compared to the picture taken at the time of deliver using facial detection and facial recognition algorithms. If the facial patterns do not match, the deliver will not occur, or further additional identification may be required. This allows deliveries to be made at locations other than the recipient's house since this process can confirm identify using a means other than address. This process may also be used for package pickup.

This written description uses examples to disclose the invention to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. While various embodiments of the invention have been described, it will be apparent to those of ordinary skill in the art that many more embodiments and implementations are possible that are within the scope of this invention. In addition, the various features, elements, methods and embodiments described herein may be claimed or combined in any combination or arrangement.

What is claimed is:

1. A delivery verification system, comprising:
a first database for storing identification information of a customer, wherein the identification information includes a customer e-mail address;
a second database for storing a specified location for a delivery of a product ordered by a customer, the product to be delivered by a deliverer to a designated recipient;
a mobile device in the possession of a deliverer of the product, the mobile device comprising a memory storage module, a GPS module for determining position coordinates of the mobile device at a given moment in time, and a camera for creating digital images, wherein upon the creation of a digital image a first software application, stored in the memory of the mobile device, tags digital location data to the digital image, the digital location data containing information regarding position coordinates of the mobile device at the time the digital image was created; and
a server in communication with the first database, the second database, and the mobile device, the server comprising a second software application for comparing position coordinates read from the digital location data with position coordinates associated with other locations;
wherein the deliverer creates a digital image of the designated recipient with the product at the time of delivery and sends said digital image to the server for comparing position coordinates tagged to the digital image with position coordinates of the specified location stored in the second database to confirm that the position coordinates tagged to the digital image are within a defined proximity of the position coordinates of the specified location and sending the digital image of the designated recipient with the product to the customer through a network using the customer e-mail address stored in the first database.

2. The delivery verification system of claim 1 wherein a customer mobile phone number is stored in the first database and the digital image is texted to the customer.

3. The delivery verification system of claim 1 wherein the digital image is created by the deliverer's mobile device and then sent to the customer with the deliverer's mobile device.

4. The delivery verification system of claim 1 further comprising a watermarking software module residing on the server for watermarking the digital image after the second software application has confirmed delivery of the product to the location, the watermarking comprising an advertisement of the maker or seller of the goods.

5. The delivery verification system of claim 1 wherein the positioning coordinates are longitude and latitude.

6. The delivery verification system of claim 1 wherein the mobile device is selected from a group comprising a laptop computer, a smart phone, a dedicated delivery tracking device, and a computer tablet device.

7. A method for providing a customer of delivery services assurance that goods ordered by the customer for delivery to a recipient were received by the recipient at a specified location, comprising:
receiving an order from a customer for the delivery of goods to a specified street address;
storing in a database the specified street address and a customer's e-mail address;
delivering the goods to the recipient at the street address;
taking a digital photograph of the recipient with the goods using a camera embodied on a mobile device configured to tag pictures with positional coordinates received from a GPS module of the mobile device;
sending the digital photograph tagged with positional coordinates to a server at a remote location;
retrieving at the server the specified street address from the database;
determining positional coordinates of the specified street address using a software application for converting street addresses to positional coordinates;
comparing the positional coordinates of the specified street address with the positional coordinates tagged to the picture, the picture showing the recipient with the goods, to determine if the specified street address and the positional coordinates tagged to the picture are within a pre-defined distance;
sending the digital photograph to the customer's e-mail address to show the customer that the recipient received the goods and, if the specified street address and the positional coordinates tagged to the picture are within the pre-defined distance, sending a confirmation that the delivery of goods was made to the specified street address.

8. The method of claim 7, further comprising applying a watermark to the digital photograph if the specified street address and the positional coordinates tagged to the picture are within the pre-defined distance.

9. A method for providing a customer of delivery services assurance that goods ordered by the customer for delivery to a recipient were received by an intended recipient, comprising:
receiving a deliver request for the delivery of goods to a recipient designated for receiving the goods;
receiving from the customer or the recipient a picture of the recipient to establish a stored recipient picture, the stored recipient picture including a facial image of the recipient;
storing in a database the stored recipient picture;
at a time of delivery of goods to the recipient, taking an second photograph of the recipient using a camera embodied on a mobile device,
executing facial recognition algorithms on the stored recipient photograph and the second photograph of the recipient to determine of the stored recipient photograph matches the second photograph of the recipient;
responsive to determining a match, completing the delivery of the goods, wherein the match indicates a confirmation that the goods were delivered to the intended recipient.

10. The method of claim 9, further comprising receiving an email address from a person establishing the delivery request; and
sending the second photograph of the recipient to the e-mail address after the confirmation is achieved.

11. The method of claim 9, further comprising receiving an email address from a person establishing the delivery request; and
sending a confirmation photograph showing the intended recipient and the goods.

12. The method of claim 11, wherein the confirmation photograph is also provided to the intended recipient.

13. The method of claim 9, further comprising watermarking the second photograph of the recipient with a watermark.

14. The method of claim 9, further comprising not completing deliver of the goods if the facial recognition algorithms do not reveal a match.

15. The method of claim 9, further comprising performing facial detection routine to identify a face of the recipient.

16. The method of claim 9, further comprising sending the second photograph of the recipient to a remote server and comparing, using facial recognition algorithms, the stored recipient photograph and the second photograph of the recipient at the server.
